(19) United States
(12) Patent Application Publication
(10) Pub. No.: US 2001/0056390 A1
(43) Pub. Date: Dec. 27, 2001

(54) Method and system hosting of multiple billers in an internet bill presentment and payment environment

(76) Inventors: Praveena Varadarajan, Sunnyvale, CA (US); Shailendra Goel, Sunnyvale, CA (US); Manish Kalbande, Sunnyvale, CA (US); Melinda Nasif, Mountain View, CA (US); Ryan Nguyen, Milpitas, CA (US); Thuy Nguyen, San Jose, CA (US)

Correspondence Address: Finnegan, Henderson, Farabow,, Garrett & Dunner, L.L.P., 1300 I Street, N.W., Washington, DC, 20005-3315, US

(21) Appl. No.: 09/885,978

(22) Filed: Jun. 22, 2001

Related U.S. Application Data
(60) Provisional application No. 60/214,248, filed on Jun. 23, 2000.

(51) Int. Cl. G06F 17/60

(52) U.S. Cl. 705/34; 705/39

(57) ABSTRACT

Methods and systems consistent with the present invention provide detailed billing information from a plurality of billers, including line-item data, wherein the line-item data for each biller is determined by the biller. A request for detailed billing data associated with a selected one of the plurality of billers is received. The requested data is retrieved and displayed. The displayed data may be formatted in a user interface also determined by the biller.

### CROSS-REFERENCE TO RELATED APPLICATIONS

This application claims the benefit of U.S. Provisional Application No. 60/214,248, filed Jun. 23, 2000, the contents of which are hereby incorporated by reference.

### FIELD OF THE INVENTION

This invention relates to Internet bill presentment and payment environments and, more particularly, to methods and systems for enabling a single Internet bill presentment and payment provider to deliver bills from multiple billers.

### BACKGROUND OF THE INVENTION

Recurring bills (such as credit card bills, utility bills, and insurance bills) are traditionally mailed to customers by billers. Upon receiving bills, customers write checks (or provide some other monetary equivalent) and then mail the checks to the billers. This traditional scheme is inconvenient and time-consuming for both customers and billers.

Internet bill presentment and payment (IBPP) systems offer an attractive solution to the problems posed by traditional billing schemes. IBPP systems permit customers to view, store, and even pay bills using a Web browser, email, or personal financial management software. Because a biller, for example, simply posts its bills on-line, the biller avoids the inconvenience of having to print and distribute bills. Customers can view bills on-line, often at any time of day and at any point during the billing cycle. This convenience is not typically available in traditional billing schemes. Some IBPP systems also offer a service that enables customers to pay bills on-line without having to mail checks to billers, another convenience and time-saving over traditional billing schemes.

Further, electronic payments are beneficial to both customers and billers. Customers are able to more accurately manage their personal finances because they know exactly when a debit will be made from an account to pay a bill electronically, as opposed to waiting for the corresponding biller to receive a check and then waiting for an associated bank to clear the check. Billers typically receive funds more quickly due to the electronic debiting.

Other benefits may also be realized by both customers and billers using IBPP systems. Enhanced customer service is one such benefit. For example, customers may access a list of frequently-asked questions from an IBPP Web site, submit change-of-address information using on-line forms, or submit billing questions or disputes using e-mail. In the traditional billing scheme, these tasks often required a customer to call a biller, typically resulting in a delay as the customer waited on hold for assistance from a representative of the biller. Billers may also be able to gather market intelligence based on customer profiles. While a traditional biller may know a customer's name and address, on-line registration at Web sites frequently includes additional questions, such as family status and household income. The biller may further use this demographic information to provide targeted marketing, either electronically, in the form of e-mail or banner ads, or by traditional mailings.

Additionally, IBPP systems provide new opportunities for revenue generation. For example, billers or banks may offer a hosting service for other companies. Not only does this consolidation provide additional convenience and time-saving to customers, but the hosting service may permit a smaller company to provide electronic bills that would not otherwise have the means to do so. The customer and/or the smaller company may be charged a fee for this service, while the added expense to the consolidator is minimal.

More generally, a third party may provide IBPP service as a consolidator. Consolidators provide customers with access to billing data from one or more billers. Consolidators may be billers and/or may act as intermediaries between customers and billers. For example, a customer may visit a single Web site of a consolidator to view and pay bills for both a utility company and a credit card company. A third party may also provide IBPP service as a host. In this case, the host does not act as an intermediary between billers and customers. The host simply maintains an IBPP system on behalf of a biller. It is transparent to the user whether the IBPP system is provided by the biller or by the host.

Billers may index and/or store data in numerous different ways. Further, each biller may have different types of information available, or different line-items. For example, a telephone bill may include an entry for each telephone call, including the number called, the time of the call, and the price of the call. A cable bill may include the cost for basic cable, and if applicable, any pay-per-view movies that had been viewed in the billing period. An insurance bill may include only the premium amount. In order to obtain the billing data from a biller, store the billing data to be displayed, and display the detailed billing data (including the varied line-items) to the customer, the consolidator traditionally was required to run an instance of an IBPP software for each biller. For example, for a consolidator or host hosting five billers, the consolidator or host must run five instances of the IBPP software on five separate machines. This is expensive in terms of software, hardware, and maintenance costs because of the differences associated with each biller's billing data and, perhaps, payment options. Alternatively, a consolidator may require each biller to conform to a standard method for indexing and storing data. This, however, limits a biller to one consolidator, as each consolidator may have a different standard method.

### SUMMARY OF THE INVENTION

It is therefore desirable to provide a method or system that permits a consolidator or host to host multiple billers using a single instance of IBPP software. Further, it is desirable to have a method or system that enables a consolidator or host to obtain, store, and display detailed billing data (including line-items) for multiple billers.

Thus, billing systems and methods, associated with a plurality of billing entities, are provided. A single instance of a bill presentment and payment application is executed. The single instance of a bill presentment and payment application is then used, as at least one request from a customer is received. The request identifies a first billing entity and a second billing entity. In response to the request, stored billing data associated with each of the first billing entity and the second billing entity are separately retrieved and presented to the customer.

Methods and systems consistent with the present invention provide detailed billing information from a plurality of billers, including line-item data, wherein the line-item data for each biller is determined by the biller. A request for detailed billing data associated with a selected one of the plurality of billers is received. The requested data is retrieved and displayed. The displayed data may be formatted in a user interface also determined by the biller.

Additional features of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several implementations of the invention and, together with the description, serve to explain the principles of the invention. In the Figures:

FIG. 1 is an exemplary Internet bill presentment and payment system in which methods and systems consistent with the present invention may be implemented;

FIG. 2 is a detailed block diagram of the biller server illustrated in FIG. 1; and

FIG. 3 is an exemplary flow chart illustrating the steps of a consolidator server providing detailed billing data for a particular biller.

### DETAILED DESCRIPTION

Overview

Systems and methods consistent with the present invention permit a consolidator or host to provide billing data from multiple billers to a customer without executing on its server computer a unique instance of IBPP software for each biller. Additionally, each of the multiple billers determines the format of the line-item for the display of their bills by the consolidator. Generally, customers receive goods, services, or value from a biller or billing entity, and thus owe the biller a sum of money. Billers have information about the sum of money owed and may also have information associated with the transaction(s) leading to this debt, or line-item information. For example, if the biller is a credit card company, the biller may have information about the total amount owed and the amount of minimum payment required. The biller may also have further information, such as details about the credit card purchases made and any related finance charges. Similarly, if the biller is a utility company, the biller may have not only information about the amount owed, but also information about usage of the utility. The biller may provide some or all of this information to a consolidator or host, upon request, who displays the information to a customer.

When a customer accesses the IBPP system via a consolidator's Web site, the customer is presented with bill summary information for each biller for whom the customer has requested IBPP services. The summary information may be the same for each biller and may include billing cycle, amount due, minimum payment amount, and/or other common data. The customer may then choose to view each of these bills in greater detail. Upon receiving a request for detailed billing information from a particular biller, the consolidator server invokes an object manager to determine an implementation object associated with the particular biller. The object manager uses a mapping available in a database or lightweight directory access protocol (LDAP) server. The object manager then invokes the determined implementation object, generating an interface that retrieves the appropriate data for the biller and presents it to the user. The biller may access the IBPP system to designate line-items corresponding to the biller's detailed billing information or to specify a user interface for the display of that billing information.

Further, the system provides a number of user interfaces, consistent with the billing data to be provided. These user interfaces are independent of the implementation objects associated with particular billers. For example, two billers having the same types of line-item data, such as two credit card companies, may be associated with one particular implementation object. Each of the two billers, however, may have a unique user interface (including, for example, a company logo) for displaying their billing data to the customer. Specifically, the system includes a number of hypertext markup language (HTML) templates. The HTML template for a particular biller may be stored in a directory associated with the biller. When the consolidator server receives a request to display detailed billing information from a particular biller, the consolidator server accesses a directory associated with the biller and displays the HTML template from that directory.

The following description of implementations of this invention refers to the accompanying drawings. Where appropriate, the same reference numbers in different drawings reference same or similar elements.

An Multi-hosting IBPP System

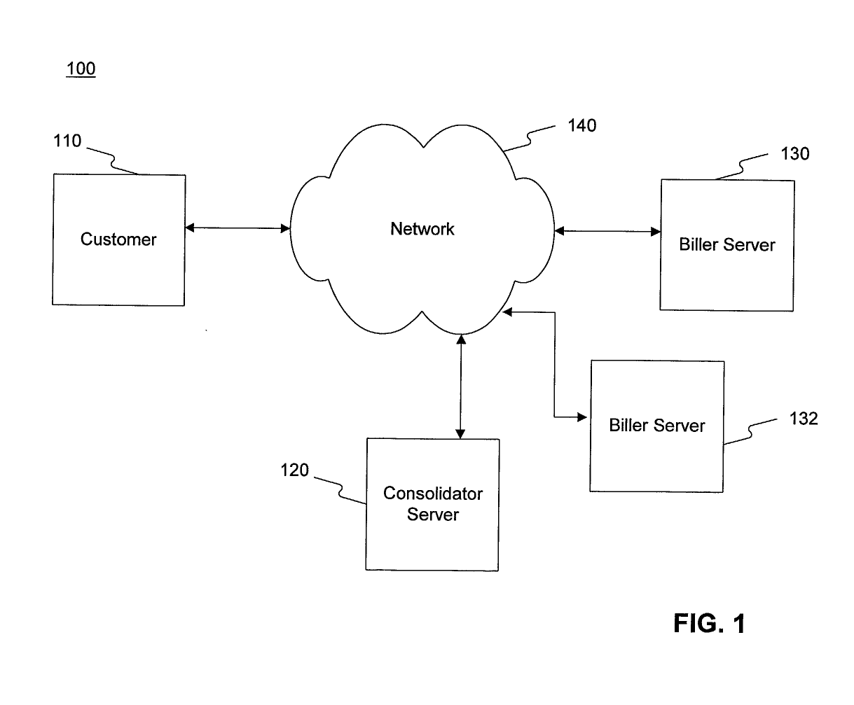

FIG. 1 illustrates an exemplary Internet bill presentment and payment system 100 that permits multi-hosting by a consolidator or host of billing information from multiple billers. System 100 includes a customer computer 110, a consolidator server 120, and biller servers 130 and 132, interconnected by network 150. Customer computer 110 has an interface, such as a browser as is known in the art, for accessing a consolidator's Web site. Consolidator server 120 includes networking software, as is known in the art, to perform a process for communicating with customer computer 110 as well as instructions for communicating with biller servers 130 and 132 and IBPP software for presenting billing data to customer computer 110. Consolidator server 120 may be associated with a consolidator, which presents the bills of multiple billers to a customer via a single Web site, or may be associated with a host, which presents the bills of multiple billers via a Web site associated with each particular biller. Biller servers 130 and 132 each include software to perform a process for communicating with consolidator server 120. Network 140 may be the Internet, a local area network, or a wide area network. Although only one customer computer is illustrated as comprising the exemplary IBPP system 100, one skilled in the art will appreciate that the exemplary IBPP system 100 may include additional customer computers. Similarly, exemplary IBPP system 100 may include a plurality of biller servers 130 and 132.

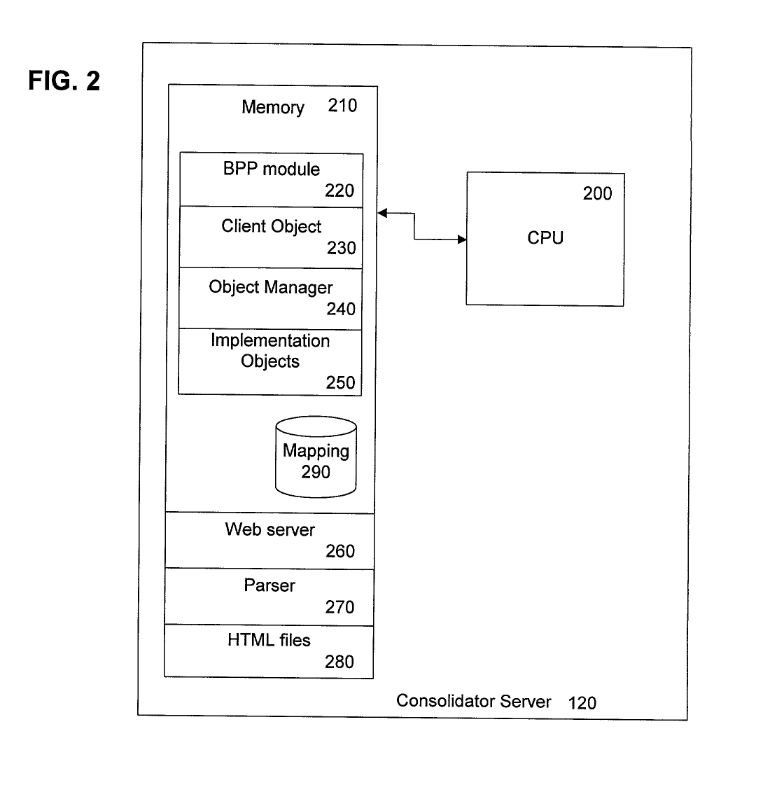

FIG. 2 illustrates the consolidator server 120 in greater detail. Consolidator server 120 includes a central processing unit (CPU) 200 and a memory 210. Memory 210 includes RAM, a hard drive, and/or any external storage capable of storing instructions to be executed by CPU 200. Memory 210 may include instructions to be executed by the CPU, for example, for implementing an IBPP program, such as a bill presentment and payment (BPP) module 220, one or more client object 230, an object manager 240, and one or more implementation object 250. Memory 210 may also include a web server 260, a parser 270, HTML files 280, and a mapping database 290. Web server 260 facilitates communication between consolidator server 120, customer computer 110, and biller servers 130 and 132. Parser 270 permits consolidator server 120 to resolve instructions received from biller servers 130 and 132 via Web server 260.

BPP module 220 displays billing information to a customer using a Web site associated with the consolidator's server and/or e-mail notifications. For example, a customer may log-in to a consolidator's Web site and view billing summary information for all billers with which the customer has enrolled in on-line billing. The summary information may be the same for each biller and may include a biller's name, billing cycle, amount due, minimum payment amount, and/or other common data. From the summary information, the customer may select a biller and the system retrieves the data, either from a database maintained by the consolidator (not shown) or directly from the biller. The system then displays the bill on the customer's browser. The particular display of the bill may be based on data stored in HTML files 280. BPP module 220 may also include a registration interface for new customers or for existing customers who wish to receive bills from additional billers via IBPP system 100. BPP module 220 may further include a biller interface for permitting a biller to register with consolidator server 120. For example, the biller interface may permit the biller to designate line-items associated with the biller's detailed billing data and/or specify a user interface for the display of the billing data.

Client object 230 receives the customer's request from BPP module 220, including biller information, for detailed billing from the particular biller. The client object then invokes the object manager 240. Object manager 240 determines an appropriate implementation object 250 based on the biller information received in the request by accessing mapping database 290. Mapping database 290 may include a database, LDAP server, or list. Object manager 240 then invokes the appropriate implementation object 250, which generates an interface. The generated interface retrieves the detailed billing data associated with the particular biller.

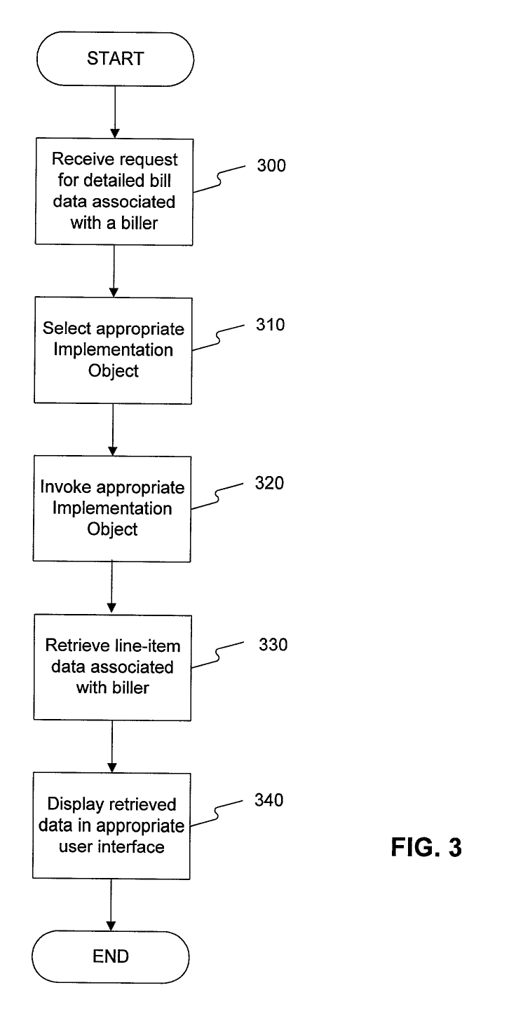

FIG. 3 illustrates the steps of a consolidator server 120 in displaying detailed bill data associated with a particular biller, consistent with the present invention. A customer accessing a consolidator's server may first view summary information for multiple billers, including billing cycle, amount due, minimum payment amount, and/or other common data. The customer then may choose to access detailed bill data by selecting a particular biller. Consolidator server 120 receives the request to access detailed bill (step 300). The request includes at least information identifying the particular biller. The request, including the biller identification information, is forwarded to object manager 240.

Object manager 240 selects an implementation object 250 associated with the identified biller (step 310). Object manager 240 may determine the appropriate implementation object 250 based on a mapping stored in mapping database 290. Thus, for example, there may be an implementation object associated with Joe's Phone and Cable Services and another implementation object associated with ABC Electric Company. It is possible for a particular biller to provide more than one type of service or good. In this case, each type of service may require a different implementation object. For example, Joe's Phone and Cable Services may provide both phone and cable services to a customer. Because the line-item bill for phone service is different than the line-item bill for cable service, two implementation objects are required. The request, in this case, would include not only the name of the biller, but also the type of bill, such as “PHONE” or “CABLE.” Mapping database 290 may include an association between one implementation object and “BILLER—PHONE” and an association between a second implementation object and “BILLER—CABLE.” One of ordinary skill in the art will appreciate that systems consistent with the present invention may provide additional or alternative parameters and mappings.

After determining the appropriate implementation object 250, object manager 240 invokes that implementation object 250 (step 320). Implementation object 250 generates an interface for retrieving the data associated with the biller.

The interface retrieves the line-item data associated with the biller (step 330). Implementation object 250 may retrieve the requested data from biller servers 130 and 132. Alternatively, consolidator server may periodically acquire data from biller servers 130 and 132 and store the acquired data in a database (not shown) until requested by the customer. In any case, when consolidator server 120 retrieves bill data from biller server 130 or 132, consolidator server 120 uses object manager 240 to determine an implementation object 250, which then generates an interface to retrieve the data. If the retrieved data is then stored by consolidator server 120, a similar process is used to retrieve the data from the database.

Finally, the retrieved data is displayed to the customer (step 340). Because each biller may present different line-item data in the detailed bill data, a different user interface must be presented. Each biller is permitted to customize a user interface, which is stored as an HTML template. The HTML template may be stored in a directory associated with the biller. When a request for detailed bill data, including the biller's name, is received, the template file that is located in the directory associated with the biller's name is retrieved. For example, an HTML template for ABC Electric Company may be stored at /templates/ABC/. If more than one type of bill is associated with a biller, an HTML template for each type of bill may be stored in a subdirectory. For example, for Joe's Phone and Cable Services, there may be two subdirectories: /templates/Joes/phone/ and /templates/Joes/cable. This permits the biller to have a unique user interface, and to display the line-items of the biller's choosing, without requiring extensive overhead on the part of the consolidator.

Systems and methods consistent with the present invention permit the hosting of multiple billers by a consolidator server running a single instance of IBPP software. Because a single consolidator server may be used, cost savings for hardware, software, and maintenance may be realized. Further, because the IBPP software invokes an implementation object associated with the biller, each biller can designate a unique set of line-item data to display to a customer. The biller may also specify a user interface, including, for example, a company logo or specialized formatting. Thus, even in a multi-hosting IBPP system, it is possible for the biller to have control over the content and display of the biller's detailed billing information.

The above-noted features and other aspects and principles of the present invention may be implemented in various system or network environments to provide automated computational tools for receiving purchasing data, identifying suppliers, and organizing data, reporting organized data, storing associations extracted from the organized data, and administering stored data. Such environments and applications may be specifically constructed for performing various processes and operations of the invention or they may include a general purpose computer or computing platform selectively activated or reconfigured by program code to provide the necessary functionality. The processes disclosed herein are not inherently related to any particular computer or apparatus, and may be implemented by a suitable combination of hardware, software, and/or firmware. For example, various general purpose machines may be used with programs written in accordance with the teachings of the invention, or it may be more convenient to construct a specialized apparatus or system to perform the required methods and techniques. The present invention also relates to computer readable media that include program instruction or program code for performing various computer-implemented operations based on the methods and processes of the invention. The media and program instructions may be those specifically designed and constructed for the purposes of the invention, or they may be of the kind of well-known and available to those having skill in the computer software arts. Examples of program instructions include both machine code, such as produced by a compiler, and files containing a high level code that can be executed by the computer using an interpreter.

Other modifications and implementations of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A billing method associated with a plurality of billing entities, the method comprising:
executing a single instance of a bill presentment and payment application;
receiving at least one request from a customer, the request identifying a first billing entity and a second billing entity; and
in response to the request, separately retrieving and presenting to the customer stored billing data associated with each of the first billing entity and the second billing entity whereby the stored billing data associated with each of the first billing entity and the second billing entity is retrieved and presented to the customer using the single instance of the bill presentment and payment application.

2. The billing method of claim 1, further comprising:
providing bill summary information for each of the plurality of billing entities.

3. The billing method of claim 1, wherein the step of retrieving and presenting stored billing data includes the steps of:
retrieving stored billing data associated with each of the first billing entity and the second billing entity;
retrieving a display template associated with each of the first billing entity and the second billing entity;
populating the retrieved display templates with retrieved billing data associated with each of the first billing entity and the second billing entity, respectively; and
displaying separately the populated templates.

4. The billing method of claim 3, wherein the display template is a hypertext markup language (HTML) template.

5. The billing method of claim 3, wherein the step of retrieving stored billing data includes:
identifying an implementation object associated with each of the first billing entity and the second billing entity;
invoking the implementation object associated with each of the first billing entity and the second billing entity to generate an interface associated with each of the first billing entity and the second billing entity; and
retrieving, by the interface, stored billing data associated with each of the first billing entity and the second billing entity.

6. A method for presenting billing data associated with a plurality of billing entities, the method comprising:
receiving at least one request from a customer, the request identifying a first billing entity and a second billing entity; and
executing a single instance of a bill presentment and payment application to retrieve and present to a customer stored billing data associated with each of the first billing entity and the second billing entity.

7. The billing method of claim 6, wherein the execution of a single instance of a bill presentment and payment application to retrieve and present customer stored billing data includes:
identifying an implementation object associated with each of the first billing entity and the second billing entity;
invoking the implementation object associated with each of the first billing entity and the second billing entity to generate an interface associated with each of the first billing entity and the second billing entity; and
retrieving, by the interface, stored billing data associated with each of the first billing entity and the second billing entity.

8. A billing system associated with a plurality of billing entities that provide goods and services to customers, the system comprising:
a module for executing a single instance of a bill presentment and payment application;
a retrieving and presenting module for separately retrieving and presenting to a customer stored billing data associated with each of the plurality of billing entities whereby the stored billing data associated with each of the plurality of billing entities is retrieved and presented to the customer using the single instance of the bill presentment and payment application.

9. The system of claim 8, wherein the retrieving and presenting module includes:
a bill presentment and payment module for displaying the retrieved billing data;
a client object for receiving at least one request from the customer, the request identifying a first billing entity and a second billing entity;
an object manager for determining, for each of the first billing entity and the second billing entity, one of a plurality of implementation objects and for invoking the determined implementation objects,
wherein the implementation object associated with each of the first billing entity and the second billing entity generates an interface for retrieving stored billing data associated with each of the first billing entity and the second billing entity, respectively.

10. The system of claim 9, further including:
a mapping database, wherein the mapping database stores associations between each of the plurality of billing entities and the plurality of implementation objects.

11. The system of claim 8, further including:
a directory including a plurality of HTML template files, wherein the bill presentment and payment module displays the retrieved billing data formatted based on at least one of the plurality of HTML template files.

12. A computer readable medium including instructions for performing a billing method associated with a plurality of billing entities, the method comprising:
executing a single instance of a bill presentment and payment application;
receiving at least one request from a customer, the request identifying a first billing entity and a second billing entity; and
in response to the request, separately retrieving and presenting to the customer stored billing data associated with each of the first billing entity and the second billing entity whereby the stored billing data associated with each of the first billing entity and the second billing entity is retrieved and presented to the customer using the single instance of the bill presentment and payment application.

13. The computer readable medium of claim 12, further comprising:
providing bill summary information for each of the plurality of billing entities.

14. The computer readable medium of claim 12, wherein the step of retrieving and presenting stored billing data includes the steps of:
retrieving stored billing data associated with each of the first billing entity and the second billing entity;
retrieving a display template associated with each of the first billing entity and the second billing entity;
populating the retrieved display templates with retrieved billing data associated with each of the first billing entity and the second billing entity, respectively; and
displaying separately the populated templates.

15. The computer readable medium of claim 14, wherein the display template is a hypertext markup language (HTML) template.

16. The computer readable medium of claim 14, wherein the step of retrieving stored billing data includes:
identifying an implementation object associated with each of the first billing entity and the second billing entity;
invoking the implementation object associated with each of the first billing entity and the second billing entity to generate an interface associated with each of the first billing entity and the second billing entity; and
retrieving, by the interface, stored billing data associated with each of the first billing entity and the second billing entity.

17. A method for presenting billing data associated with a plurality of billing entities, the method comprising:
receiving at least one request from a customer, the request identifying a first billing entity and a second billing entity; and
executing a single instance of a bill presentment and payment application to retrieve and present to a customer stored billing data associated with each of the first billing entity and the second billing entity.

18. The computer readable medium of claim 17, wherein the execution of a single instance of a bill presentment and payment application to retrieve and present customer stored billing data includes:
identifying an implementation object associated with each of the first billing entity and the second billing entity;
invoking the implementation object associated with each of the first billing entity and the second billing entity to generate an interface associated with each of the first billing entity and the second billing entity; and
retrieving, by the interface, stored billing data associated with each of the first billing entity and the second billing entity.

19. A method for obtaining billing data associated with a billing entity, the method comprising:
sending, to the billing entity, a request for billing data; and
receiving, from a server associated with multiple billing entities, the requested billing data.

20. A billing system associated with a plurality of billing entities that provide goods and services to customers, the system comprising:
a plurality of servers, each associated with one of the plurality of billing entities; and
a host server running an instance of a bill presentment and payment application, wherein when a customer requests billing data reflecting transactions associated with one of the plurality of billers the requested billing data is provided by the instance of the bill presentment and payment application without starting another instance of the bill presentment and payment application.
